(19) United States
(12) Patent Application Publication
(10) Pub. No.: US 2013/0200790 A1
(43) Pub. Date: Aug. 8, 2013

(54) ARRAYS OF LIGHT SOURCES ENERGIZED WITH BRANCHED AND LOOPED ELECTRODES FOR SIGNAGE

(71) Applicant: Almax RP, Corp., Kirkland, WA (US)

(72) Inventor: Kevin Stuffle, Tucson, AZ (US)

(73) Assignee: ALMAX RP, CORP., Kirkland, WA (US)

(21) Appl. No.: 13/838,293

(22) Filed: Mar. 15, 2013

Related U.S. Application Data
(63) Continuation-in-part of application No. 13/278,761, filed on Oct. 21, 2011.

(51) Int. Cl. H05B 33/08

(52) U.S. Cl. CPC H05B 33/0821
USPC 315/52

(57) ABSTRACT

An array of light sources, e.g. LEDs, can be energized with electrical current provided through power bus electrodes. The array, which can be branched or looped, can coupled to a power source at two or more substrate feedthroughs. One or more alphanumeric characters and/or as line art can be defined by the layout of the light sources and electrodes. The light intensity emitted by each light source is determined by creating a tuned electrode—resistor—light source network. Each light source is coupled to the electrodes via one or more resistors, which are trimmed when formed, e.g., based a plurality of vectors defining the network, or by manually determining the voltage at each node of each electrode. This circuit design technique can be used to create signs comprising plural letters, or discrete characters that can be assembled by end users.

### RELATED APPLICATIONS

This application is a continuation-in-part of a copending patent application Ser. No. 13/278,761, filed on Oct. 21, 2011, the benefit of the filing date of which is hereby claimed under 35 U.S.C. §120.

### BACKGROUND

Commonly assigned U.S. patent application Ser. No. 13/278,761 discloses a technique for producing an array of light sources that are energized using generally parallel first and second power bus conductors, where the current through each light source is controlled with a bridging resistor, each bridging resistor having a resistance value that is controlled to achieve a desired current through the light source. The resistance of each resistor is controlled by varying selected parameters, such as the width of the material applied to a substrate to form the resistor, or the resistivity of the material comprising the resistor. In the examples provided in this previous application, the light sources were surface mounted light emitting diodes (LEDs), although it was emphasized that the disclosed technique is usable with other types of light sources besides LEDs. The techniques for calculation of individual resistance values for the bridging resistors and the sizing thereof for permissible heat loading, and a technique for determining the maximum number of LEDs in the array based on electrode width and LED pitch were disclosed in this previous application. However, these techniques and examples were limited to the case where the power bus conductors supplying current to all of the LEDs were not branched and were energized from adjacent ends (i.e., at one or both end) of the power bus conductors). The disclosure of that patent application was primarily directed to light strips that produce about the same or some desired intensity of light output from each of the light sources comprising the light strips. Further, it was demonstrated how the light strip could be formed to produce alphanumeric characters, and an example was provided illustrating the use of this technique to form a letter “P.”

In this prior application, the maximum number of LEDs in a ladder configuration was related to the applied voltage, and the dimensions and resistivity of the electrodes, but based on application of a power source to one or both ends of the power bus conductors. However, there are many applications in which it will be desirable to connect a power source to other portions of the electrodes that are used for energizing the LEDs. Accordingly, it would be desirable to estimate the maximum number of LEDs in a branched and or looped electrode network emanating from a feedthrough that is connected to the power bus electrodes at other locations besides their ends. Also, it was shown in the prior application that the resistors could be sized using a maximum Watt Loading, which determines the permissible temperature rise design constraint, by relating the length and width of the resistors to the applied voltage and current through the resistors. However, it would be desirable to relate the minimum length of the resistor solely to the voltage drop across the resistor and, to relate the minimum width of the resistor solely to the current carried through the resistor, and to apply the same relation to size the electrode width from a watt loading standpoint. Further, although the prior application explained how to calculate the voltage at any node along a ladder array configuration of LEDs, to determine the value of the bridging resistor. But, it would further be desirable to determine the voltage drop along a single electrode, in the case of branched and or looped power bus electrodes.

The further development of the techniques that were disclosed in the earlier application should enable more complex configurations of LEDs (other light sources) to be developed for applications such as signage. It would thus be possible to create new types of signs that meet a variety of different needs. For example, discrete alphanumeric characters formed by laying out circuits of LEDs using these techniques would enable consumers to purchase specific letters or numbers and assemble a desired sign on a supporting structure, by electrically coupling the characters in parallel to a suitable power source. These and other benefits of the such further development of the techniques for configuring circuits of light sources will be evident from the following discussion.

### SUMMARY

In this application the design methodology and the techniques for performing the required calculations required for the product application of signage are disclosed. Practical applications for signage utilizing the previously disclosed technique typically require branched and or looped electrodes and require energizing from arbitrary points along the electrodes. Such applications require greater insight of the fundamental physical processes involved and considerable sophistication of the design methodology and associated calculations.

The processes for fabrication and the signage final articles are claimed. Also claimed are several stylistic aspects that enhance the desirability and marketability of the signage final articles.

This application specifically incorporates by reference the disclosure and drawings of the patent application identified above as a related application.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIGS. 1A and 1B illustrate an exemplary lighted sign created by laying out LEDs (or other types of light sources) so that they are evenly spaced apart along a centerline that is branched or looped;

FIG. 2 is an exemplary printed circuit for the LED pattern shown in FIG. 1 and created in accord with the present approach, which forms a tuned printed silver electrode printed carbon resistor—LED network;

FIG. 3A illustrates a circuit diagram for a series-connect LED and resistor coupled through leads to a voltage source

FIG. 3B illustrates an exemplary schematic pictorial diagram corresponding to the circuit diagram of FIG. 3A;

FIG. 4 is an exemplary schematic diagram of a one dimensional ladder array of LEDs for estimating a maximum number of LEDs for a specified electrode width and LED spacing;

FIG. 5 is a graph illustrating a characteristic resistor profile for the resistors in a ladder array;

FIG. 6 is a schematic illustration corresponding to the sign of FIGS. 1A, 1B, and 2, showing the anode and cathode vectors and the branch indices vectors used to solve for the circuit design parameters;

FIG. 7 is an exemplary vector tree for a circuit used for an “OPEN” sign (like that shown in FIG. 11);

FIG. 8 is an example showing the mapping of the anode and cathode node indexes for the example of FIG. 6, to the corresponding LED index;

FIG. 9 is a flowchart illustrating exemplary logic for the circuit design process method;

FIG. 10A illustrates an exemplary embodiment showing how individual letters for a sign can be created using the present novel approach and each character can be separately energized by pig tails that can be coupled to a power source;

FIG. 10B illustrates an example showing how discrete alphanumeric characters comprising LEDs or other light sources in a circuit designed using the present approach can be created to enable an end user to produce a desired sign by assembling the corresponding characters that are coupled to power bus bars;

FIG. 11 illustrates an exemplary embodiment of a sign created using the present approach, which uses through-holes for rivets that connect the sign to leads coupled to a power source; and

FIG. 12 shows an exemplary embodiment of a sign that includes a wire harness adhered to the back of the substrate, which is connected to multiple feedthroughs and to a connector that is used to couple to a power source.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Overview

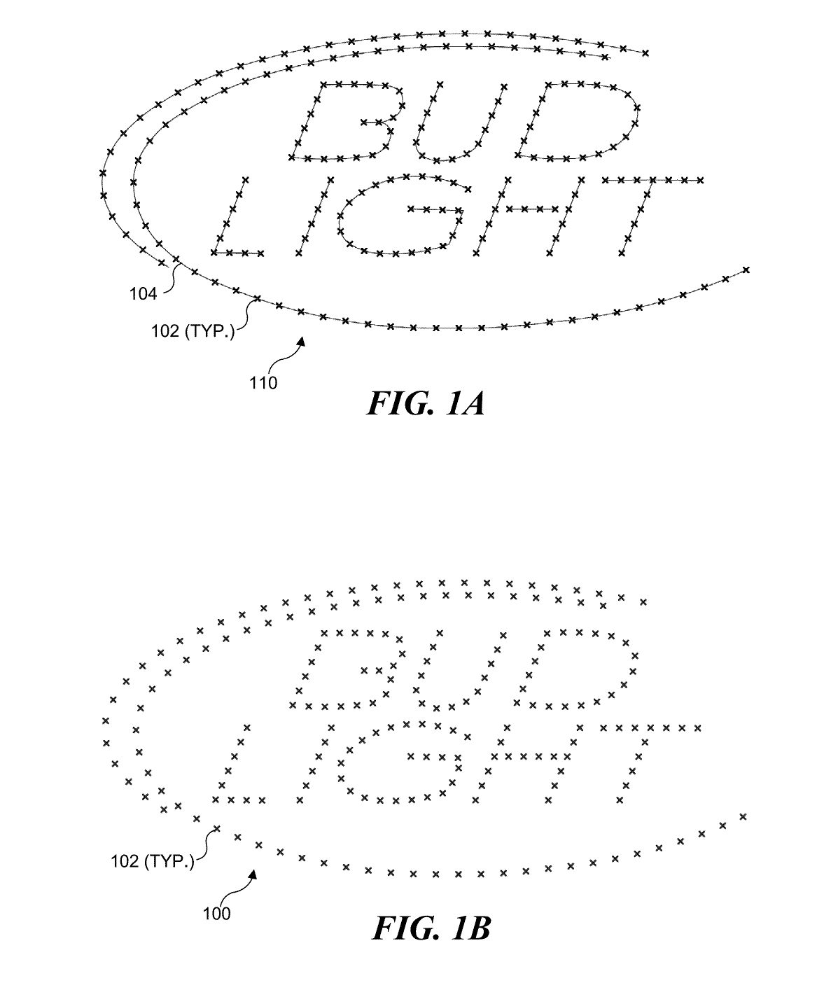

When light sources are distributed evenly on a centerline laid out in a desired pattern, the human eye perceives the distribution and typically recognizes the pattern. The centerline may be branched and or looped to create recognizable alphanumeric characters or symbols, as is illustrated in FIG. 1A, which shows LEDs (or other types of light sources) as points 100 that are generally evenly distributed on a centerline 102 to create a sign 100 with the words “BUD LIGHT” (a trademark for a well-known beverage). FIG. 1B illustrates sign 100 without the centerline to emphasize that the points corresponding to the position of the LEDs provide the visual cues to which the human eye responds to interpret the pattern. Although signs created with distributed LEDs or other light sources are not new, they have been limited mostly to wired and through-hole mounted LED's or light bulbs, where the light intensity of each light source is controlled without consideration of the neighboring light sources. The control of each light source is typically achieved in the past by several techniques. In the first of these techniques, LEDs are used that include internal circuitry for regulating current and can be placed on a parallel two-wire network. Another prior approach that has been used is to connect the LEDs in an addressable matrix circuit, and then control the electrical current to each LED with an integrated circuit. A third approach, which can be problematic, for example, if one of the light sources burns out, is to connect all of the light sources in series and tightly control the current supplied to the series-connected light sources with a current-regulated or variable-voltage power supply. None of these techniques of the prior art are advantageous for creating low profile, unobstructed patterns of light sources and energizing with a low cost power supply. The present approach overcomes problems associated with such prior art techniques by using a tuned printed resistor for controlling the current supplied to each LED included in a network energized with parallel power bus electrodes. Unlike the previous patent application referenced above, the LED network may be branched and or looped.

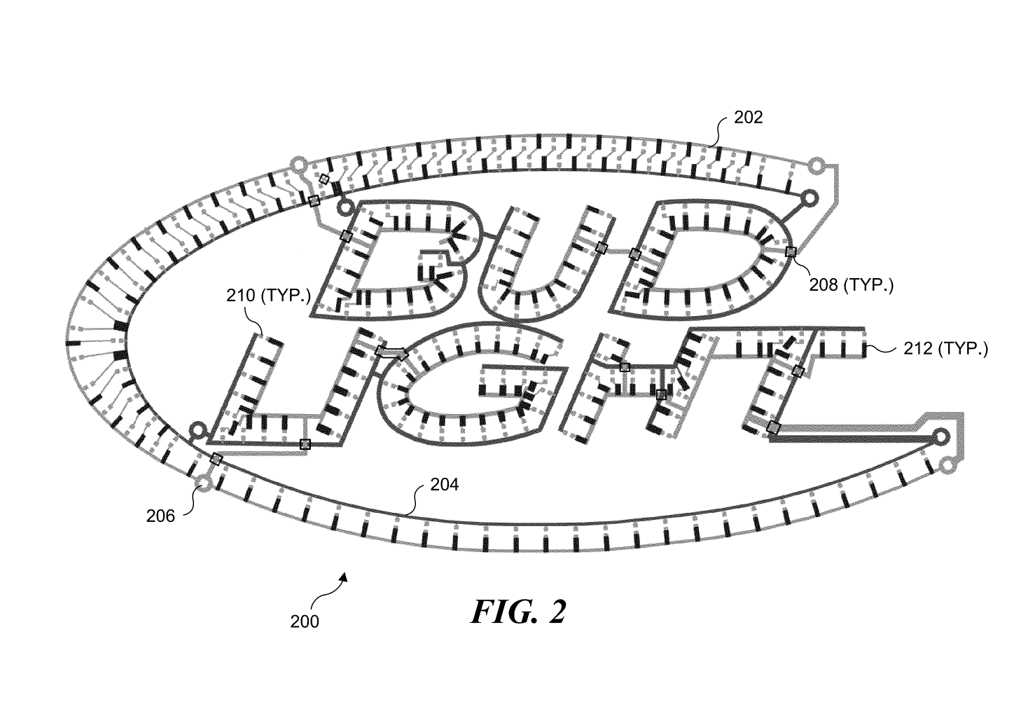

FIG. 2 shows a printed circuit created for the LED pattern depicted in FIG. 1 and employing the present novel approach to control the electrical current to each LED. The printed circuit is a tuned printed silver electrode—printed carbon resistor—LED network. The network is tuned by controlling parameters of the resistors to provide a desired current to energize each LED, and thereby, a desired light intensity emitted by each of the LED's. In this example, the outer “swooshes” surrounding the alphanumeric characters of the sign are populated with blue light emitting LEDs, the inner text letters are populated with white light emitting LEDs, and the electrodes and resistors are tuned to give equal intensity to the light emitted by the LEDs in each set of colors.

All of the design principles that were disclosed in the prior application are used in the present novel technique for lighting circuit design and configuration, are expanded to provide greater depth and sophistication. For instance, in the prior application, the maximum number of LEDs in a ladder configuration was related to the applied voltage, and the dimensions and resistivity of the electrodes. In the present approach, that same relation, slightly modified, is used to estimate the maximum number of LEDs in a branched and or looped electrode network emanating from a feed though, but greater insight is provided by the techniques discussed below. Also, it was shown in the prior application that the resistors could be sized using a maximum Watt Loading, which determines the permissible temperature rise design constraint, by relating the length and width of the resistors for each light source to the applied voltage and current through the resistors. That technique has been expanded in the present approach to relate the minimum length of the resistor solely to the voltage drop across the resistor and, to relate the minimum width of the resistor solely to the current carried through the resistor. Also, that same relation now is applied in the present approach to size the electrode width from a watt loading standpoint. In addition, the prior application described how to calculate the voltage at any node along a ladder array configuration of LEDs, which was then used to determine the value of the bridging resistor at that node. That relation, which was used to determine a voltage drop along a single electrode in the prior application, is now also applicable in the case of branched and or looped electrodes. The following discussion will show how the voltage drop along the electrode conforms to a characteristic curve, and how that curve is effected by the electrode's width.

The prior application disclosed that a lighting circuit can be formed on a thin, transparent substrate, which may be flexible. Such flexibility can be particularly advantageous to applications for signage and banner artwork. An additional stylistic aspect of the present novel approach is the use of a surface bonded flexible copper strand braid to distribute current from power feedthroughs to a single electrical connector that can be coupled to a suitable DC power source. The copper braid can be hidden behind the electrodes to reduce visual obstruction on signage. The present approach is particularly well suited for use of a fire-rated transparent polycarbonate substrate, which can be important for signage that may be mounted in a window or mounted on another types of transparent support, or hung on an interior wall. Without any implied limitation, exemplary alternatives to the flexible copper braid include: (a) metallic wires having a flattened cross-sectional shape; (b) a metallic conductive tape; (c) die-cut metallic sheets; (d) metallic conductive bars; and, (e) conductive braids of other metals besides copper.

Lighting circuits configured according to the present novel approach can be used in almost limitless different applications. Examples of such applications include signage made with selected discrete alphanumeric characters that include one or more desired characters, words, or phrases. It is also contemplated that one or more alphanumeric character lighting circuits formed in this manner may be used in non-signage applications. Without any intended limitation, such non-signage applications might include, for example, the use of lighted characters on vehicle license plates or for aircraft identification.

### DESCRIPTION OF EXEMPLARY EMBODIMENTS

The basic description of the fabrication process and final article was described in the prior patent application. In its most simple form, it is basically an array of LEDs that uses a printed circuit in which the LEDs (or other types of light sources) are placed in parallel across a common pair of power bus electrodes (referred to as “power bus conductors” in the previous application) and which also employs individual trimming resistors for each LED to compensate for the voltage losses along the electrodes, such that equal current is supplied to each LED, and thus, equal intensity emitted light is produced by each LED. In the prior application, the disclosed technique was limited to a single pair of unbranched electrodes, and the number of LEDs in the array could approach the theoretical limit for a uniform width and thickness of power bus electrodes, which is a limiting case that provides the greatest utilization of the power bus electrode material. The electrodes used in this type of lighting circuit are particularly suited for an additive printing process and can be supported on a thin substrate that may be transparent for minimum visual obstruction.

The use of a positive displacement ink plotter is particularly advantageous for printing a circuit on the substrate. This type of plotter deposits ink in a precise volume per length swept by the plotting stylus, utilizing a coordinated 4-axis motion controller, where the fourth axis is used to displace a syringe (or piston within a cylinder) such that the volume of ink that is extruded from the stylus is proportional to the length swept in the X-Y plane. Typically, the Z axis is only used to raise or lower the pen tip, (however, coordinated motion along a path in X-Y-Z coordinates is possible for depositing the conductive ink on non-flat surfaces, although two additional axes may then be required to maintain the pen tip normal to a curved surface). In the case of planar motion of the plotter stylus, the width of the extruded trace is determined by the volume to path length extrusion ratio, and the pen height. In practice, the pen height is maintained fixed, and the width of the trace is varied by varying the volumetric ratio. For this reason, the width of a given trace is constant as the volumetric ratio is set for a given trace. The extruded trace may not be completely flat, depending on the pen tip height and the width. However, the cross-sectional area will be equal to that of a flat trace of the predicted width and thus, the surface resistivity for a flat trace may be used in the calculations.

A desired overall width for the electrodes and for the resistors can be achieved by plotting adjacent traces of a given (narrower) width, so that the sum of the widths of the adjacent traces is equal to the desired overall width. Therefore, it is possible to achieve any desired overall width to yield a desired precise resistance. Note that none of these details are intended to limit the applicability of this approach, since it should be understood that other techniques for applying the power bus electrodes and resistors to a substrate. For example, masked and etched copper bonded substrate may be used instead of a substrate with a printed silver ink, to produce a desired electrode pattern. This alternative removes the constraint of maintaining sectional constant width electrodes but entails greater tooling and poorer material utilization. It is also possible that if the electrodes are sufficiently wide, there would be no need for varying the resistance of the trim resistors, or that just one trim resistor could be used in series with the whole circuit.

### Resistor Sizing

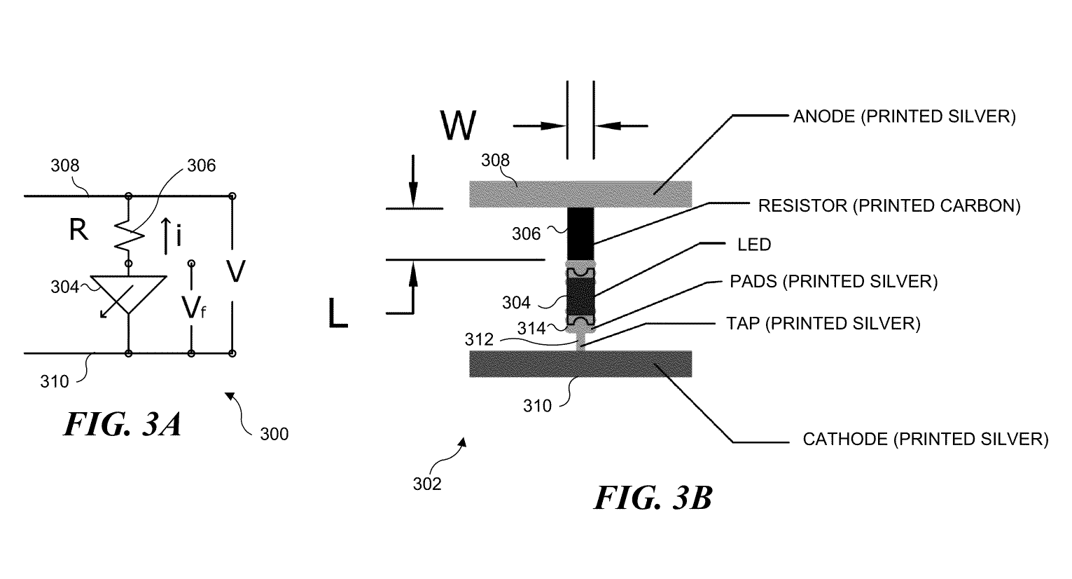

At the heart of the present novel approach is the optimum design and printing of the individual trim resistors, which is achieved by applying greater insight than in the previous application. The resistors used in the present approach can comprise, for example, printed carbon, and they have constant thickness and a constant width, i.e. they are generally rectangular. In this case, the specific surface resistivity, which is defined in Ohms per square, may be used to calculate the resistance of the resistor. FIGS. 3A and 3B respectively illustrate a circuit diagram 300 and a schematic pictorial diagram 302 showing a typical resistor 306 (printed with carbon ink) connected in series with an LED 304, to bridge between the two power bus electrodes 308 and 310. A tap 312, which is printed using silver ink, connects power bus electrode 310 to a pad 314 on which LED 304 is mounted. The power bus electrodes are both printed using silver ink.

A primary design constraint is that the temperature rise of resistor 306 should not exceed a maximum value. This constraint is a safety, a lifetime. and a performance issue. The temperature rise is related to the heat flux and overall heat transfer coefficient of the resistor. The overall heat transfer coefficient is dependant upon operational parameters such as vertical or horizontal orientation, construction parameters such as substrate conductivity, and whether the resistor is mounted, free hanging, or embedded. In practice it is more practical to forego the calculation of the heat transfer coefficient and base the sizing on the heat generated per unit surface area, which is termed Watt Loading, for a given set of operational and construction parameters. The maximum Watt Loading, WLmax, is determined experimentally. Once determined, it is used to size all the resistors in a circuit. The equations used to size the resistors are given below:

$$R := \frac{{ρ}_{c} \cdot L}{W} \qquad ( 1 )$$

wherein, resistance, R, is equal to specific surface resistivity, ρ_{c} times the length, L, divided by the width, W.

$${WL}_{max} := \frac{Q}{A} \qquad ( 2 )$$

wherein, maximum Watt Loading, WLₘₐₓ, is equal to the Power, Q, divided by the area, A, of the resistor.

And, in accord with Ohm's law, the voltage drop across the resistor, V-V_{f}, is.

(V−V_{f}):=iR (3)

where, i is equal to the current through the resistor. The power, Q, is thus equal to the current times the voltage drop across the resistor, the area is equal to the length times the width, which results in:

$${WL}_{max} := \frac{( V - {V}_{f} )}{L \cdot W} . \qquad ( 4 )$$

Substitution of Ohms law and the equation for resistance shows that the minimum length, Lₘᵢₙ of the resistor is a function of only the voltage drop:

$${L}_{min} := \frac{( V - {V}_{f} )}{2.54 \sqrt{{WL}_{max} {ρ}_{c}}} . \qquad ( 5 )$$

Similarly, substitution shows that the minimum width, Wₘᵢₙ, of the resistor is a function only of the current, i_{LED}, through the LED:

$${W}_{min} := \frac{{i}_{LED}}{2.54 \sqrt{\frac{{WL}_{max}}{{ρ}_{c}}}} \qquad ( 6 )$$

Redundantly, the value of the resistance at the maximum Watt Loading is equal to the quotient of the minimum length and width times the specific surface resistivity:

$$R := {L}_{min} \cdot \frac{{ρ}_{c}}{{W}_{min}} \qquad ( 7 )$$

Therefore, if it were desired to achieve the same current, and thus, equal light intensity output from each LED in an array of identical, evenly spaced LEDs along a smooth path, and to maintain equal Watt Loading, the width of the trim resistors would remain constant and the lengths would decrease with the voltage drop along the electrodes. Similarly, if the electrodes were of constant width, driven from an adjacent end, and the pitch (spacing between LEDs) were uniform, then the lengths of the resistors would vary in accordance with a characteristic curve that is discussed below. However, in practice, it may be more aesthetically appealing to maintain a constant resistor length and electrode parallelism, at least in sections, say comprising a letter, as shown in FIG. 2 in the section LIG where two different resistor lengths are used for the letters LI and the letter G. In this case, the width of the resistors can be increased to achieve the required resistance and the Watt Loading would decrease from the maximum correspondingly. It is also possible to vary the length of the resistors by varying the length of the tap—see FIG. 3B, and as shown in the swooshes in FIG. 2.

The same Watt Loading equations can be used to size the electrodes, and even the lead wires (accounting for the circular cross-section) to avoid excessive heating. The type of material used for the electrodes, which in at least one exemplary embodiment is printed silver, can have somewhat different heat transfer characteristics than carbon, but in practice it has been discovered that using the same value of maximum Watt Loading achieves the desired result of avoiding excessive temperature rise. A charge balance yields the total current though the electrode, and that current is used in substitution for i_{led} in the equation for width. Also, the surface resistivity of printed silver is substituted for that of carbon. However, the minimum electrode dimensions are more typically limited by considerations discussed below, but in certain instances, Watt Loading may be the dominant factor.

It must be noted that it is possible to design lighting products where the network thermal loading is sized for a pulse width modulation duty cycle direct current (DC) waveform, as is commonly employed to energize LEDs, and that option is also included in the present novel approach. The human eye perceives the intensity of light emitted by an LED energized by a rapidly pulsing current as constant and essentially equal to that of an LED energized with a full persistent DC current. Such a power source employs a pulsed DC voltage that is stepped on and off at a desired frequency for a percentage of the waveform. The watt loading will be reduced by the percentage of the wave form during which the current is zero, and the resistor areas can be shrunk accordingly. It is recognized that in some applications, it may be considered preferable to energize light sources with non pulsed width modulated power sources for aesthetic reasons. The tradeoffs have to be weighed in any actual application.

It also must be noted that a light source could be composed of a set of LEDs that are in a defined series or parallel configuration. For instance it is possible to run sets of three different color LEDs in series. In this way the set has an effective forward voltage which is the sum of the three individual forward voltages and the same design methodology can be employed.

### Maximum Number of LEDs on an Electrode Based on Resistive Voltage Losses

The maximum number of LEDs that can be fed by an electrode is typically dictated by the IR voltage losses along the electrode. Although, there is no absolute requirement for an electrode to be of constant width, or even constant thickness, it can be shown that optimum material utilization and minimum visual obstruction is achieved in these conditions, although that exercise in not performed here. There are practical limitations on the thickness of inks in a printed circuit and therefore a standard thickness has been adopted. That thickness determines the surface resistivity used in these calculations. The maximum number of LEDs that can be fed is then related to the width of the electrode.

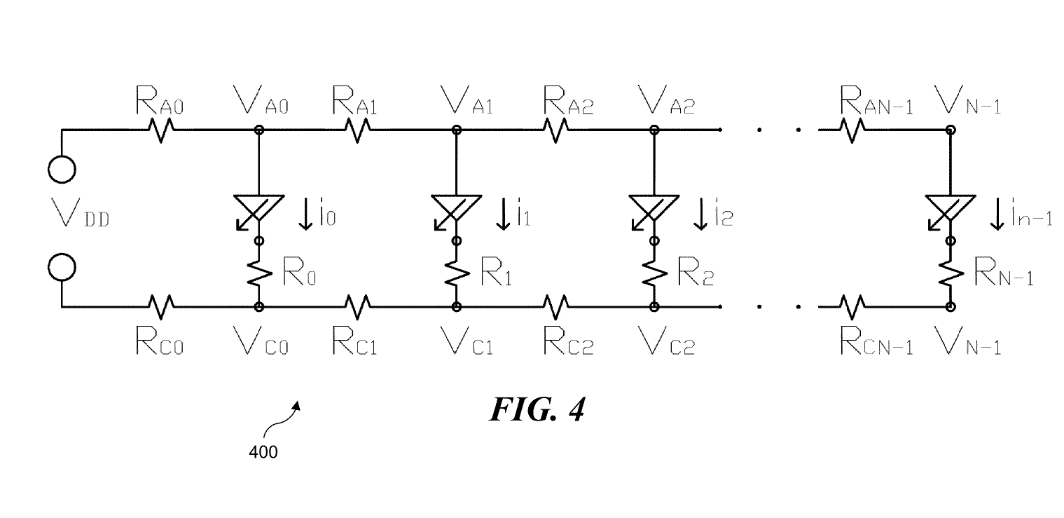

FIG. 4 shows a schematic diagram of a one dimensional array 400 of LEDs 406 in a ladder type configuration that serves as a prototype for estimating the maximum number of LEDs relative to the width of a cathode power bus electrode 402 and an anode power bus electrode 404, and the LED spacing. The electrodes are energized from adjacent ends. If the ladder is straight or smoothly curved such that the sum of each of the cathode and anode segment lengths totals a constant length, and the electrode widths are constant, then the individual electrode resistances can be summed, and a constant segment resistance, R_{seg} can be substituted for their values. Note that trim resistors 408 are shown on one side of the LEDs, but the trim resistor for an LED may be on both sides of the LED or alternated on either side with no adverse consequences. Further, the resistance of the tap should be thought of as part of the resistance of the resistor. If each LED 406 is identical, then a single forward voltage can be used, and if the current though each LED is the same, then a single current, i_{LED}, can be substituted for the individual currents for each LED. Given these conditions, the following relations apply. The segment resistance (i.e., the resistance of the power bus electrodes between their connection to successive LEDs) is related to the width of the electrodes according to the following equation.

$${R}_{seg} := 2 \cdot pitch \frac{{ρ}_{Ag}}{{W}_{electrode}} \qquad ( 8 )$$

The available voltage, V_{DD}-Vf, must be greater than or equal to the sum of the resistive voltage losses, as indicated by the following.

V_{DD}−V_{f}≧i_{LED}·R_{seg}N_{SUM} (9)

where Nₛᵤₘ is the sum of all integers from 1 to N (the number of LEDs in the ladder). A value for Nₘₐₓ, which is the maximum N that produces the maximum Nₛᵤₘ satisfying the above condition, can be calculated using the routines immediately below. The maximum segment resistance for the power bus electrodes can then be calculated and used to calculate the minimum electrode widths for the desired number of LEDs, which is N.

$${N}_{max} := \vert \begin{matrix}M ← 0 \\ {M}_{sum} ← 0 \\ while {M}_{sum} \leq {NSUM}_{max} \\ ‖ \begin{matrix}M ← M + 1 \\ {M}_{sum} ← 0 \\ for n ∈ 0 … M - 1 \\ {M}_{sum} ← {M}_{sum} + ( M - n )\end{matrix} \\ M ← M - 1 \\ M\end{matrix} \\ {N}_{sum} := \vert \begin{matrix}{M}_{sum} ← 0 \\ for n ∈ 0 … {N}_{max} - 1 \\ {M}_{sum} ← {M}_{sum} + ( {N}_{max} - n ) \\ {M}_{sum}\end{matrix} \qquad ( 10 )$$

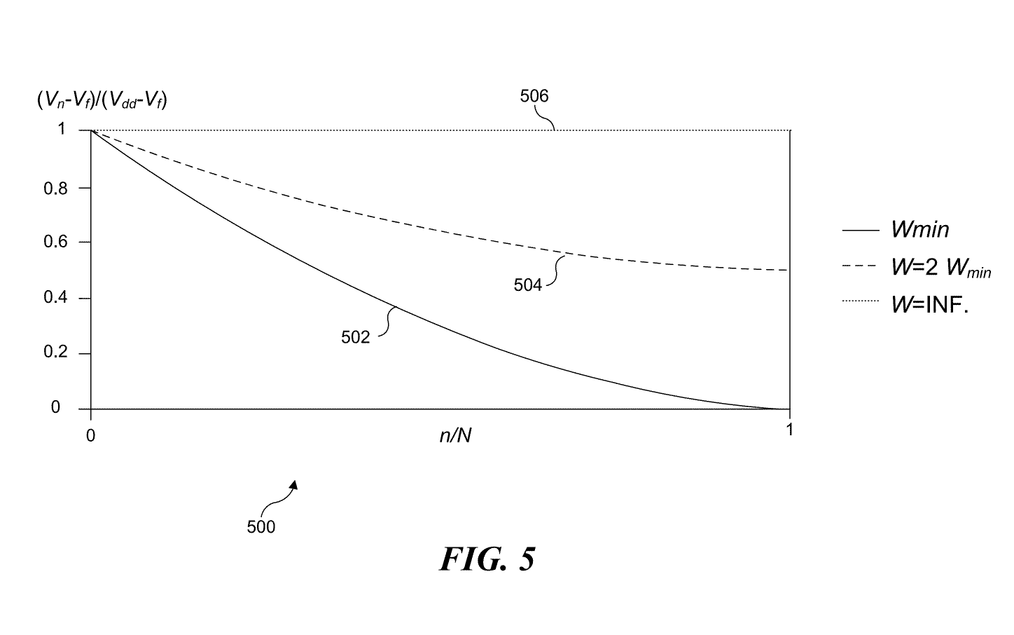

Consider that the anode power bus electrode does not “see” the cathode power bus electrode because current at each LED branch is equal, no matter the voltage profile on the other electrode. Therefore, the same relationship applies to a single unbranched electrode, where the segment resistance of the electrode is that of that electrode alone. The voltage drop to each LED node along the ladder and thus, the required resistor length in the case of equal Watt Loading forms a characteristic profile. The case where the resistive losses exactly match the available voltage (V_{DD}-V_{f}), which occurs at the minimum electrode width, is illustrated in a graph 500, shown in FIG. 5, where the width of the power bus electrode equals the minimum width. This graph includes a profile 502 for the case where the electrode width is equal to the minimum width, and a profile 504 where the width is equal to twice the minimum. It can be seen that there is a steep length decrease at the start, which asymptotically approaches zero as n (the resistor number) approaches Nₘₐₓ. The implications are that the electrode span may have to be reduced, or its width increased, when N approaches the theoretical maximum, to avoid a resistor that is too short or too wide. Also, note that the profile approaches a flat line 506, as the electrode width limits to infinity, meaning that a single value trim resistor can be used for all of the LEDs, in that case.

The above relationships demonstrate the technique for practical sizing of the electrodes and their spacing for the layout of a circuit. Branching and looping must be considered in the correct context. Consider two identical looped power bus electrodes feeding LEDs spaced apart at an identical pitch, and starting at a power feedthrough and ending at a common node. The looped electrodes would not see each other, since the voltage drop to their ends would be the same and would thus exhibit an identical voltage. Therefore, the same maximum number of LED concept applies to each electrode branch. Next, consider a branched electrode, where the branch is identical to the rest of the electrode, and where the branch node approaches the feedthrough, The maximum number of LEDs in a singularly branched electrode could be up to double that of an unbranched electrode. In such instances, a designer can choose to increase the width of the lead segments to accommodate the extra current.

Once the power bus electrode widths and the spacing (as determined by the maximum length of a resistor), the centerline of the LEDs can be offset to provide a template for the electrodes. Feedthrough locations are determined such that array lengths for a configuration with less than the maximum number of LEDs are achieved. The electrode geometries and the resistor and tap intersection locations quite likely will require modification in locations that are geometrically constrained, such as corners, near branch intersections, and at crossovers. In such cases, the artistic capabilities of the designer can play an important role, although it is envisioned that the design procedure may be entirely computer-automated in the future. The next step in the design of the circuit is determining the sizes of individual resistors for each LED, which is explained below.

### Tuning the Electrode—Resistor—LED Network

In practical circuit networks required for signage, it is necessary to give up most of the simplifying design constraints that were implicit in the above-referenced prior patent application. The power bus electrodes won't always be parallel and will often not be energized from adjacent ends, but rather at arbitrary points along their lengths. In these cases, the voltages along the anode power bus electrode must be calculated independently from those along the cathode power bus electrode. The nodes across each LED must then be mapped to determine the voltage across each series connected LED—trim resistor set. The values of the trim resistors are then determined, based upon the voltage difference. Energizing (or current sinking in the case of the cathode) at a point along a power bus electrode may in some instances just create two or more new single-ended electrode paths or, in other instances, may create a branched electrode path. The same procedure of stepping down the path and calculating the voltage drop still applies, however, with the requirement that a charge balance is performed to determine the initial currents in each branch that should be subtracted at branch nodes along the primary electrode path. So, to summarize, the procedure for determining the voltage at each node is first to perform a charge balance to determine the starting currents in the primary path and its branches, and then to step along the primary path and subtract the LED current at the LED nodes and the branch currents at the branch nodes and determine the voltage drop (or rise if along the cathode power bus electrode) in each segment between two nodes. The voltage drops are then summed and subtracted (or added if on the cathode power bus electrode) from the initial voltage. The charge balance requires that the initial current in an electrode equal the sum of the LED currents on a path, its branches, and its sub-branches. However, the electrodes may also be looped—at least in some places.

The procedure for determining the node voltages for looped electrodes requires an additional constraint, namely, that the voltage at any point in a closed loop must be independent of the path taken to that point. This constraint results in a requirement to solve a set of simultaneous equations to determine the initial currents in the converging branches of a loop. Any network can be solved with simultaneous equations; however, it can be more practical to employ a root finding technique, wherein the initial currents are varied and the degrees of freedom are limited according to a charge balance. Once the initial currents are determined, the same procedure of stepping down the electrode paths can be used to determine the node voltages. It is possible to determine voltages at each node along the electrodes, for any power bus electrode—LED—resistor network using this approach. In fact, several exemplary designs, including some shown below, have been completed in this fashion using just a spread-sheet and vectors (where a vector is defined as single column of numbers) generated using a computer assisted drawing (CAD) software application. However, the procedure is extremely cumbersome for all but very simple configurations. Also, if any parameters change in the course of the design, the manual procedure can require extensive rework. Nevertheless, it is possible to substantially or even completely generalize and automate the design process and calculations, as discussed below, which is an integral part of the present novel approach. However, it should be understood that there are many ways to automate network circuit calculations, other than the one exemplary technique discussed herein. It is acknowledged that other techniques can be used that are fundamentally equivalent to the exemplary technique that is discussed herein and are equally capable of providing a solution, and it is not intended that the present novel approach be limited in any way to this exemplary circuit design procedure.

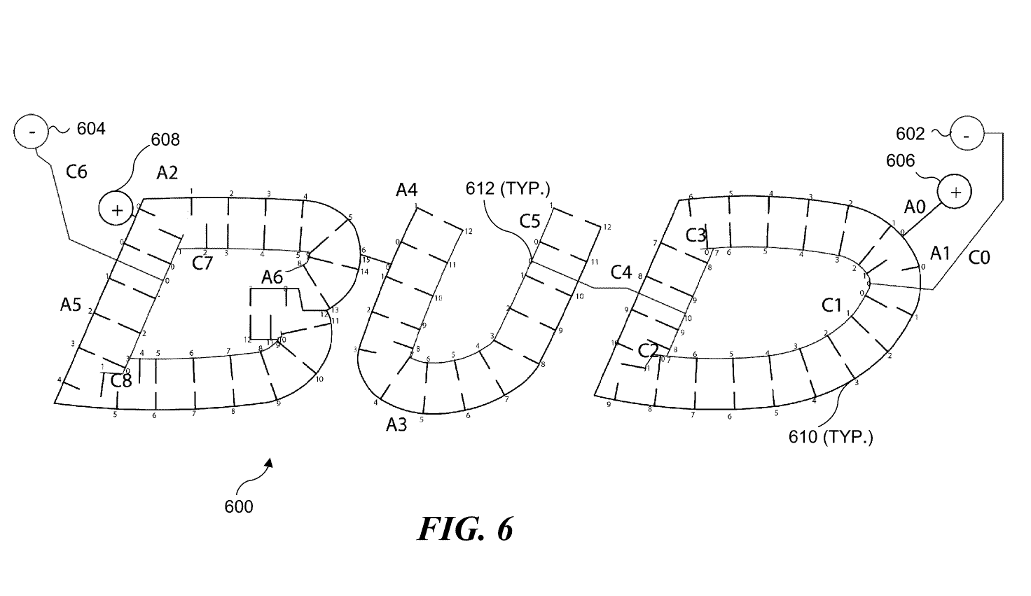

The exemplary circuit design procedure can be understood using the “BUD” alphanumeric character portion of FIG. 2, as shown in a schematic diagram 600 in FIG. 6. Two sets of vectors are shown, including the A vectors (A0 through A6), which comprise the Anode (+), and the C vectors (C0 through C8) that comprise the Cathode (−). The nodes are indexed sequentially emanating from power feeds 602 for the anode and 604 for the cathode, where 0 is a first node index, and the node indices increase sequentially in the direction of decreasing voltage for the Anode and in the direction of increasing voltage for the cathode. A power feed 606 for the cathode and a power bus feed 608 for the anode are also provided at the opposite side of the sign. If two vectors form a loop, they must both end at a common node. Branch vectors are likewise indexed sequentially from a highest voltage for the anode, and from a lowest voltage for the cathode. There are two types of nodes, LED nodes 610 and branch nodes 612. It is possible for a node to be both a LED node and a branch node, but in that case, it would be indexed twice, to simplify the charge balance. It is also possible for two or more branches to emanate from a node, and for three or more vectors to loop and converge at a node. There could be types of nodes that are neither a branch node nor a LED node, e.g., where a transition in electrode width occurs or simply at a point at which to measure the voltage, but such nodes are not considered in the present example for the same charge balance consideration. These types of nodes (i.e., neither branch nor LED) add another level of complexity to the algorithm, and at some time in the future, can be added and be handled by the algorithm without much further effort.

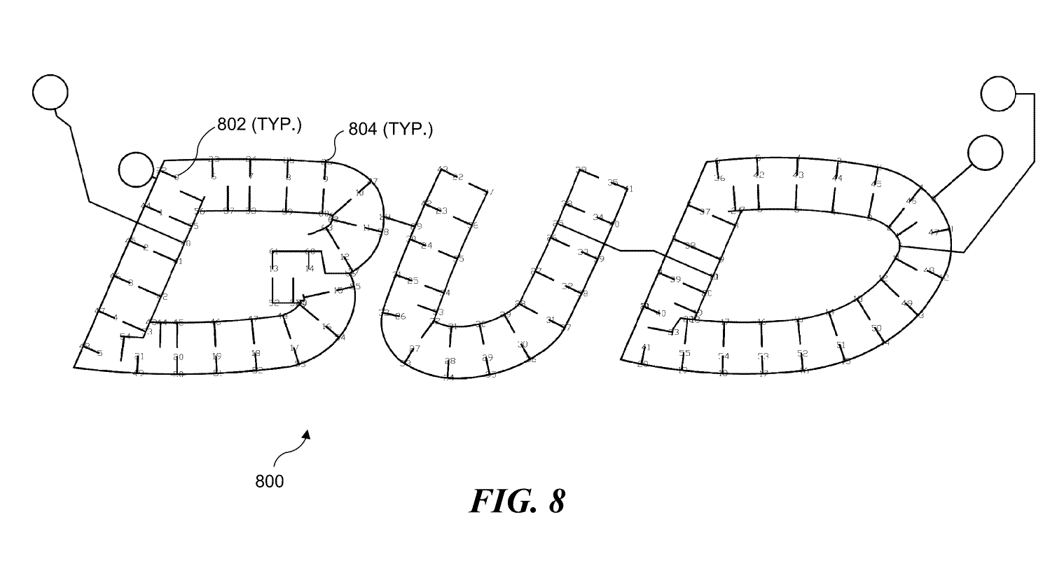

The vectors at a node can be thought of as columns of numbers, where the numbers are the resistances of the segments preceding the node. There is no need for any geometrical interpretation. A branch indices vector is associated with each A and C vector, which are named the B and D vectors respectively and have the same index. These branch vectors (not shown in FIG. 8) are a list of the branch node indices on the associated branch vector. It is necessary to establish nomenclature rules, such that voltages are calculated at the branch nodes prior to the present exemplary algorithm attempting to iterate down the branch vectors. This concept is subtle, but extremely important for the algorithm to succeed. Also, it is necessary to be able to associate the branches and sub-branches for the charge balances. The nomenclature rules that satisfy these requirements are as follows:
1. The first vector A0 emanates from a feedthrough (e.g., power feed 604) and is termed “a primary vector.” Typically, the longest vector possible will be chosen as the first vector.
2. The next vector will be the present vector's first branch, if it exists; if not, the next vector will be selected by going back to the preceding vector's next branch, if it exists, and so on, all the way to the ends of the branches and all the way back up to the next primary vector. This approach is repeated until all the vectors are indexed.
3. A vector must end at a common node, if one exists.

The same rules are used to index the C vectors. Once the A and C vectors are indexed, the B and D branch index vectors are generated by listing all the branch node indices in order on the associated A and C vectors. Next, it is necessary to create vectors to identify common nodes for both the anode and the cathode. The common nodes are the nodes where two vectors come together to form a loop, which must occur at a node. Two vectors ACV and CCV are used to identify common vectors indexes ACV, CCV. The common vector indices are listed in ordered pairs. The common node on each vector can be identified as the last node of the vector according to the nomenclature rules.

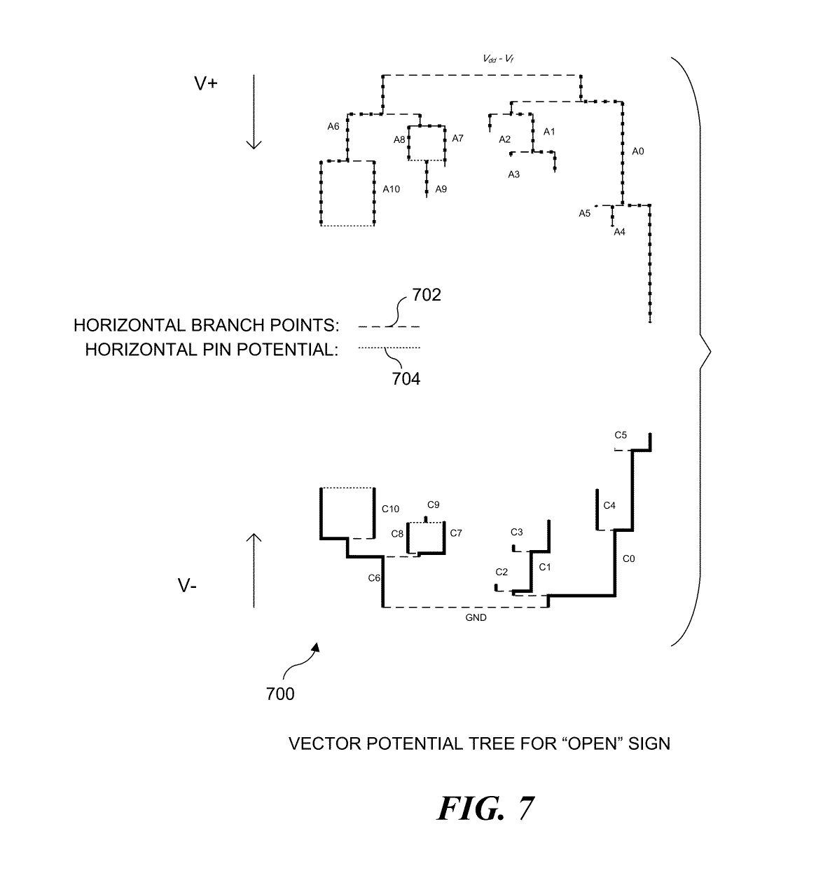

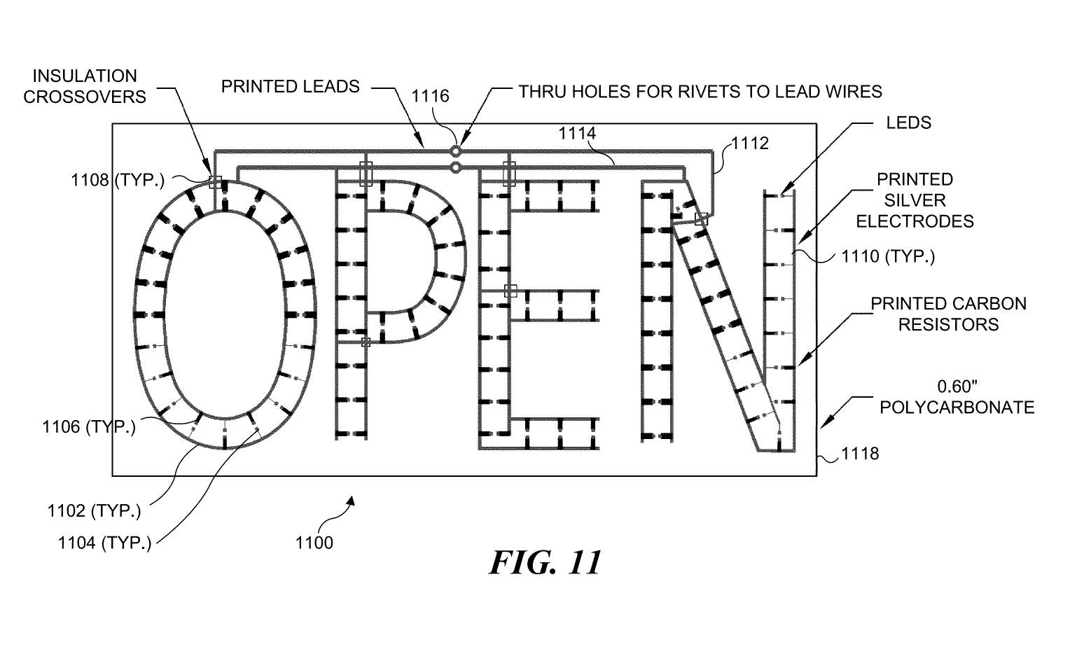

FIG. 7 demonstrates how the vectors can be interpreted from the standpoint of a vector potential tree 700. This Figure is for an “OPEN” sign (e.g., like that shown in FIG. 11). Vector potential tree 700 shows how the potential drops down each A vector for the Anode and rises up each C vector for the cathode. Each LED node is a point on a vertical portion of the respective vector. Long dash horizontal lines 702 represent branch nodes, and horizontal dotted lines 704 represent common nodes where the potential is pinned to equivalent values. The potential across each LED corresponds to the vertical height between an LED node on an A vector and a mapped node on the C vector below it. The Figure also illustrates the vector naming procedure, as described in the above nomenclature rules.

The A,C (PATH), B,D (BRANCH INDEX), and ACV, CCV (COMMON) vectors along with the LED currents, which are specified, are all that is required to determine the voltage drops along the power bus electrodes. These vectors, with two new vectors ALED, CLED (MAP), comprise a complete set of vectors for solving for the values of the resistors in the network. Next, the two mapping vectors, ALED and CLED, which map the anode and cathode node indexes to the corresponding LED index, must be produced, as illustrated in FIG. 8. LEDs 802 may be indexed in any order, but in this example, they are ordered in the way they would be written. The anode and cathode vector indices have been stacked, i.e., the A vector and C vector indices have respectively each been placed in a single AI vector and a single CI vector and incremented by the total number of indices in the preceding vectors minus one. In this way, each node on the electrode has at least one unique index 804. Common nodes have two unique indices, and either of these indices may be used in the map vector. In the next step, the ALED and CLED vectors are generated by listing the respective electrode nodes in order of the LED index. Presently, these vectors are generated with an interactive routine in a CAD software package that creates a list of the indices in the order picked, but the vector generation could be automated in the future.

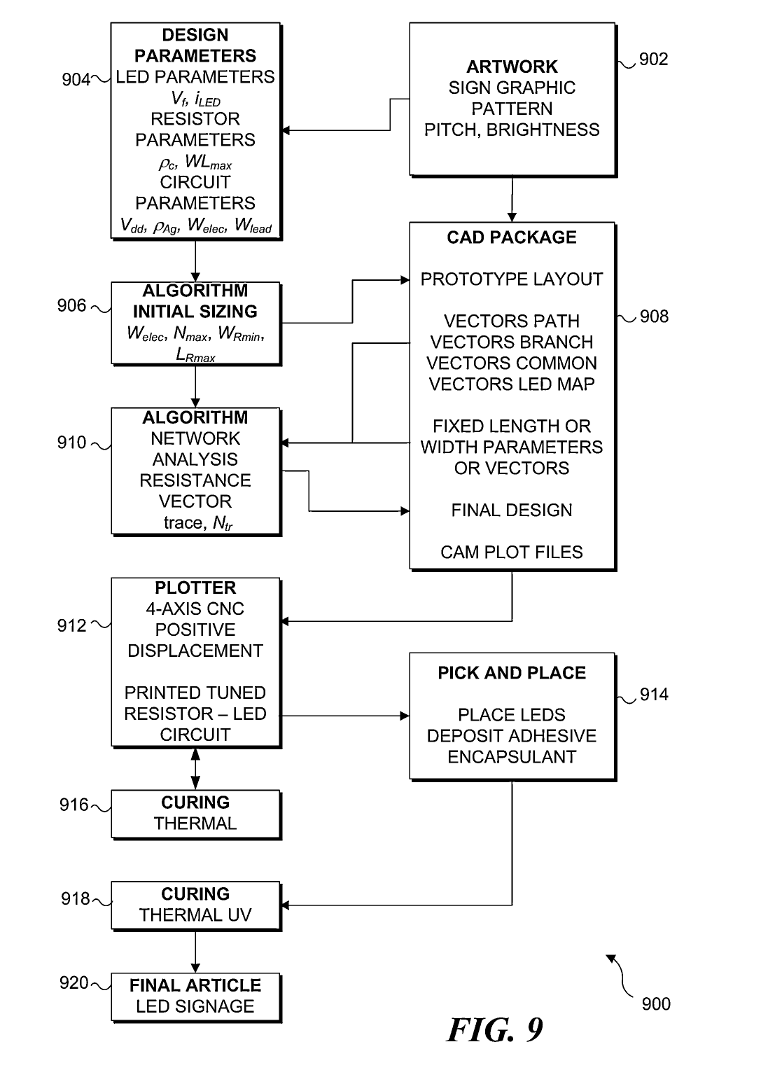

FIG. 9 is a flowchart 900 showing exemplary logic used in the design process methodology. As indicated in a block 902, an artist or other graphics designer might supply a sign pattern for use in the CAD software package and specify pitch (i.e., spacing between LEDs), and desired brightness of the light emitted by the LEDs. In a block 904, a circuit designer supplies the LED, resistor, and circuit design parameters that are required for the resistor values to be calculated, such as the forward voltages of the LEDs and the LED currents, the applied voltage and the maximum Watt Loading. Also, the resistivities of the electrode and resistor materials are required for the procedure. All these parameters could be vectors, but more typically, since they comprise just a few constant values, they can more readily be entered as constants in the algorithm (although in some instances, such data entry may be more cumbersome). Next, in a block 906, an exemplary algorithm provides an initial sizing, supplying parameters W_{elec}, Nₘₐₓ, W_{Rmin}, and L_{Rmax} to a CAD software package in a block 908. The CAD software package implements prototype layout, by creating the vectors path, vectors branching, vectors common, and vectors LED map. The CAD software package also produces fixed length or width parameters of vectors for input to an algorithm that produces a network analysis resistance vector, trace, Nₜᵣ, and tweaking thereof, in a block 910. The output of the algorithm in block 910 is used by the CAD software package in block 908 to produce a final design and to create computer-aided manufacturing (CAM) plot files.

In a block 912, the CAM plot files are supplied, for example, to a 4-axis positive displacement plotter, which uses the plot files to produce a printed tuned resistor-LED circuit on a desired substrate. The printed circuit is then thermally cured in a block 916. Further, using the CAM plot files, a block 914 provides for pick and placing of LEDs on the printed tuned-resistor LED circuit so that they are electrically bonded to the LED pads of the circuit and secured with an adhesive encapsulant. The resulting circuit is then cured with ultraviolet light in a block 918, producing a final LED signage article for use or sale in a block 920.

It will be understood that the arrows shown between the blocks in FIG. 9 are not strictly one way. The path vectors, branch vectors, map vectors, and common node vectors are generated in the CAD software package in block 908 using specially written routines. Likewise, the A and C vectors may be products of associated vectors, such as width, but more typically have one, two, or a few constant values, which enables these vectors to be generated as lengths rather than resistances and is an easier task for a CAD programmer to implement. These parameters that were discussed above, and the set of vectors noted in the preceding discussion comprise the complete set of data required to calculate the values of the trim resistors. Once the resistances are calculated, their length and width parameters are associated with an ordered group of lines representing the resistors in the CAD software package in block 908 and are drawn automatically. The circuit can then be plotted in block 912. Using routines in a CAD software package, the vectors are quickly generated, and the algorithm is also rapidly executed. The bulk of the design time is presently spent in the CAD software package in performing the initial layout and tweaking, including locating the feedthroughs and offsetting the centerline of the LEDs to produce the electrodes using the parameters generated in the initial sizing exercises of block 906, and in performing manual modifications to the electrodes and tap locations in the geometrically constrained regions and accommodating the crossovers and resizing leads. These tasks presently require a designer's artistic skill, but are fertile grounds for automation.

The exemplary computer algorithm used to generate the resistor parameters is central to the present novel signage circuit design process. When carried out in this manner, the algorithm may be completely general, i.e., it can be applied to any set of vectors, as described above, with very little or no modification. The algorithm works in concert with the CAD software package and with specially written CAD routines. The algorithm will eventually be written as a routine within a CAD software package or be compiled and used as a function within a CAD software package. The algorithm provides the insight and capability to make new types of signs and is a tool for implementing the present novel approach, but is merely one example of how this approach can be implemented. It will be understood that other alternative mechanisms to facilitate the design and construction of lighted signs are encompassed by the claims that follow below.

Table 1 (below) sets forth more details of the logic employed in the exemplary computer algorithm developed for working with the above-referenced set of vectors. Each component of this logical progression can involve routines of varying sophistication, and the present exemplary implementation leaves room for evolution and variation. For instance, the path and branch vectors (ABCD), which are vectors of vectors, are presently read-in with separate vector indices, whereas they could be stacked and read in as four vectors with no index; and then unpacked in the algorithm. The insight of the vector nomenclature and iteration logic is much more central to the approach used in this technique for the design of signage. Two important aspects of the algorithm are building the initial path current vectors IIA and IIC, which is actually implementing the charge balance, and following the nomenclature indexing order of the A and C vectors during the voltage iteration, based on the B and D branch index vectors, which generates vector start index vectors, VIA and VIC. The charge balance only operates on the path vector lengths, the branch vectors, and the common vectors and finds the forward sum of the number of all LEDs on the primary vectors and their branches and sub-branches. The vector start index routine operates only on the path vectors and the branch vectors based on the nomenclature logic. The nomenclature logic enables these vectors to be consistently determined. These two routines are used to build the node current vectors for the voltage iterations along the power bus electrodes. A route finding routine is used to trim the initial path current vectors IA and IC to match the voltage at the common nodes. The trimming has to be in accordance with the degrees of freedom of the charge balance. An initial estimate is provided using an average of the forward sums of LEDs on the converging branches. This routine still requires user interaction in more complex situations. Once the network is solved, the LED trim resistor values are calculated for each LED by subtracting the voltages across the mapped nodes, subtracting the forward voltage of the LED, and then dividing the result by the LED current. The algorithm presently yields resistor trace width and repeat vectors based on the lengths of the elements of an associated ordered group of lines in the CAD software package, which are supplied to the algorithm as parameters and ordered logistically.

TABLE 1
LIST of STEPS IN COMPUTER ALGORITHM

| | |
|---|---|
| 1. | ENTER PARAMETERS |
| | V_{f}, i_{LED} (for LED); |
| | L.1, L2, ρ_{c} (for Resistor); |
| | V_{dd}, ρ_{Ag}, W_{lead}, W_{elect1}, W_{elect2} (for Power Bus Electrodes) |
| 2. | READ COMPLETE SET OF VECTORS |
| | A, B (path); |
| | B, C (branch); |
| | ACV, CCV (common); |
| | ALED, CLED (map) |
| 3. | BUILD RESISTANCE VECTOR FROM PATH VECTORS and |
| | PARAMETERS |
| 4. | BUILD INITIAL PATH CURRENT VECTORS, IA and IC, |
| | CHARGE BALANCE FOR INTIAL VALUES, IIA and IIC |
| | determine number of LEDs on each path vector; |
| | determine number of sub-vectors and forward sums; |
| | set trim current ratios and dgf; |
| | estimate initial trim currents |
| 5. | BUILD PATH VECTOR START INDEX VECTORS |
| | Follow vector tree logic to generate start index vectors VIA and VIC |
| 6. | BUILD BRANCH INDEX LENGTH VECTOR |
| | error check only |
| 7. | BUILD NODE CURRENT VECTORS |
| | set node current to LED current if LED node, one half if common; |
| | set node currents to initial current plus trim at branch nodes |
| 8. | ITTERATE VOLTAGE VECTORS VA and VC |
| 9. | COMPARE VOLTAGE AT COMMON NODES |
| | generate voltage difference vector; |
| | compare elements to tolerance; |
| | scale trim current and return to second bullet of Step 7 if greater |
| 10. | STACK VOLTAGE VECTORS |
| 11. | GENERATE LED TRIM RESISTOR VECTOR R |
| | determine voltage across LED nodes and subtract forward voltage; |
| | determine resistance values by dividing by LED current |
| 12. | GENERATE VECTORS of WIDTH and REPEAT parameters for |
| | CAD |

### Applications of Circuit Design Technique

The application of the techniques discussed above facilitates production of a whole new class of signage and methods for production thereof. Complex character and line art patterns of surface mount LEDs can thus be created using printed electrode—tuned resistor networks, which enables energizing the signage components directly using a low cost DC power supply, which may optionally be pulse-width modulated. Using these techniques, low cost illuminated signage may be printed on thin and flexible substrates characterized by having a low profile (by using low profile LEDs) and low visual obstruction, and which can be energized directly with two power bus electrodes. This type of signage product is comparable to neon signage in many ways. However, the new signage offers advantages in weight, cost, safety, energy consumption, and aesthetic appeal. It also enables placement of the resulting signage in locations not possible hereto such as embedded in a suitable coating material, or surface mounted on or embedded in windows.

In addition, this new technology can be used to produce discrete alphanumeric characters that can be combined to create low cost consumer signage. Another aspect to this novel approach enables signage to be rapidly prototyped by employing the generalized exemplary algorithm for network analysis, as discussed above. Without such an algorithm, the design costs would be prohibitive for consumer applications, because of the lengthy design time required. Use of the above-described exemplary novel rapid prototyping techniques and design methodology enables unique low cost signage to be created by printing tuned LED resistor networks comprising custom signage. It is contemplated that a system for creating such signage can be compartmentalized into a single unit, like a 3D printer, and sold to sign shops, hardware stores, or other appropriate businesses.

The present novel approach is also applicable to high volume production processes, such as screen-printing silver ink or etching copper flex for forming power bus electrodes. The design methodology described above can be adapted to non-generalized curved bounded region electrodes that are more readily formable by these process.

### Alternative Techniques

One alternative approach would be to provide an etched copper flex or screen-printed silver circuit that employs a continuous gap to separate an array of bridging LEDs in series with tuned resistors to form alphanumeric characters and/or line art. In this case, the resistance to each node can either be predicted or measured. Further, if the areas and weights of the power bus electrodes thus formed are sufficiently great that their resistance effectively approaches zero, the values of the trim resistors might all be equal. In that case, it may be possible to forgo the use of the tuned resistors altogether and instead, optionally employ a single trim resistor on a power lead and a DC power supply that may produce a variable voltage or be current controlled. These simpler alternatives would still be encompassed in this novel approach for creating signage. However, there are still some advantages to a ground plane approach to design such circuits for use in certain applications, for example, where light blockage or shielding is desired.

### Discrete Alphanumeric Characters

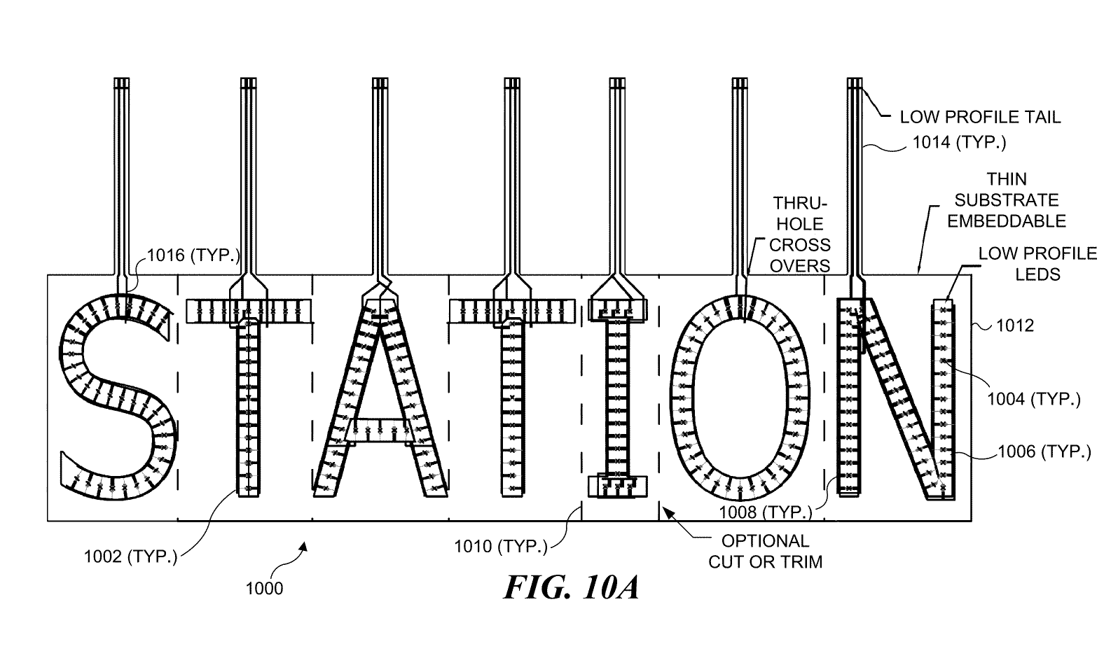

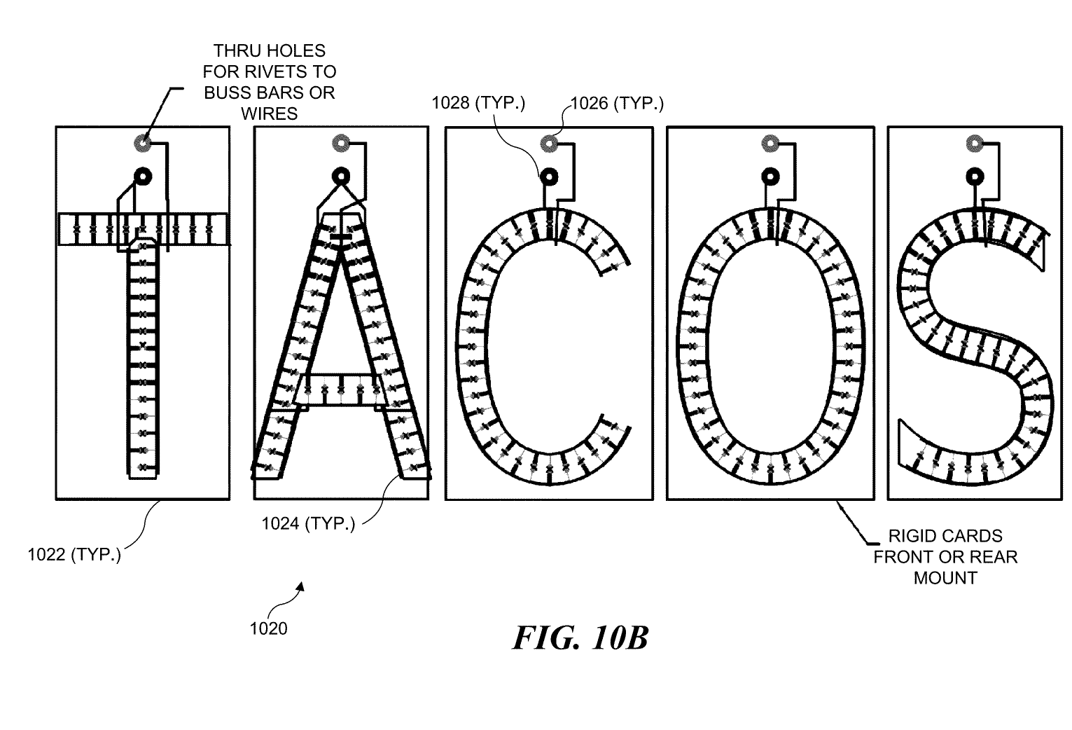

FIGS. 10A and 10B show how individual discrete alphanumeric characters can be produced and replicated to reduce design time for creating semi-custom signage. The letters in these examples were designed using the manual direct iteration procedure discussed above. Just one full character set allows endless replication to spell any desired words. In the exemplary embodiment of a sign 1000 shown in FIG. 10A, letters 1002 are arranged on a computer and spaced-apart LEDs 1004 overlay outlines 1006 of characters for a selected font that is followed by power bus electrodes 1008, to achieve a desired spacing on a substrate 1012. The power bus electrodes of the letters are each individually supplied electrical power by connecting a set of low profile tails 1014—one for each letter—to an appropriate DC power supply (not shown). The cross-sectional size of the electrical conductors in these low profile tails is sufficiently great that the letters may all be considered to have about the same applied voltage. The final signage article can be very thin and thus easily embeddable. The letters can be cut free around their outlines to further facilitate placement or cut into individual letter blocks along trim lines 1010 and assembled separately to create the desired signage at a desired site.

An exemplary embodiment of a sign 1020 shown in FIG. 10B demonstrates the use of individual letter cards 1022 that can assembled by an end user onto a set of parallel bus bars (not shown) using through holes 1026 and 1028 for rivets that can supplied for connecting each letter 1024 to the bus bars or to leads that are coupled to a DC power supply. Such alphanumeric cards and the required accessories (such as the power bus bars and power supply) for energizing the characters on the cards can be sold at hardware stores or other appropriate commercial establishments for assembly by a consumer end user to create a desired sign.

For most residential or light commercial signage, a customer will likely prefer an easily managed single electrical connector that eliminates the need to connect multiple loose wires. Also, a clear substrate that is minimally obstructed by circuitry is also desired so that the signage can be hung or mounted in a window or on glass doors without blocking the view. A readily hand-portable substrate for the signage, which can range in thickness from poster weight to light window plaque thickness, is desired. Polycarbonate is a particularly desirable material for the substrate because of a combination of properties that is possesses, including clarity, mechanical, density, low cost and fire ratings. The wire harnesses required for the signs employing the individual letter approach can be cumbersome and an impediment to creating larger signs and achieving customer acceptance, but the use of bus bars that can be electrically coupled to each letter with pop-rivets when creating a user created, custom assembled sign should greatly enhance the acceptance of this product.

It is also possible to use materials other than polycarbonate for the substrate employed in this novel technique. For example, the substrate may be formed of polyester, a polyimide plastic (such as Kapton™), an acrylic plastic, or glass. Further, a number of different combinations of materials to form the power bus electrodes and substrate can be employed. Without any intended limitation, examples include: (a) an etched metallic flex conductor bonded to a polyimide substrate; (b) an etched metallic conductor on a fiber reinforced plastic substrate; (c) a conductor that is screen printed on either a polyester or polycarbonate substrate; or, a metallic conductor that is mask-evaporated onto a glass substrate. Also, the resistors can be formed of indium tin oxide (ITO) applied to a substrate such as polyester. Nickel can also be used for forming the resistors.

FIG. 11 is an exemplary embodiment of a sign 1100 reading “OPEN” that can be mass-produced and which employs only a single co-linear lead wire and connector. The letters have been placed on a single set of printed leads applied to a substrate and which extend to a single set of feedthroughs. Each letter of sign 1100 has been tuned for the voltage drops in the printed leads for each LED. The number of LEDs on sign 1100, in this example, approaches the maximum for the electrode dimensions and the set of feedthroughs. Sign 1100 includes letters 1102, each comprising a plurality of LEDs 1104 and trimmed resistors 1106. An electrical insulation pad 1108 is provided where printed leads 1112 or 1114 that are coupled to one of power bus electrodes 1110 must cross over the other power bus electrode, to prevent short circuiting between the power bus electrodes. Printed leads 1112 and 1114 are each provided with through holes 1116 through a polycarbonate substrate 1118 that are sized accept rivets that can be connected to leads coupled to an appropriate power supply.

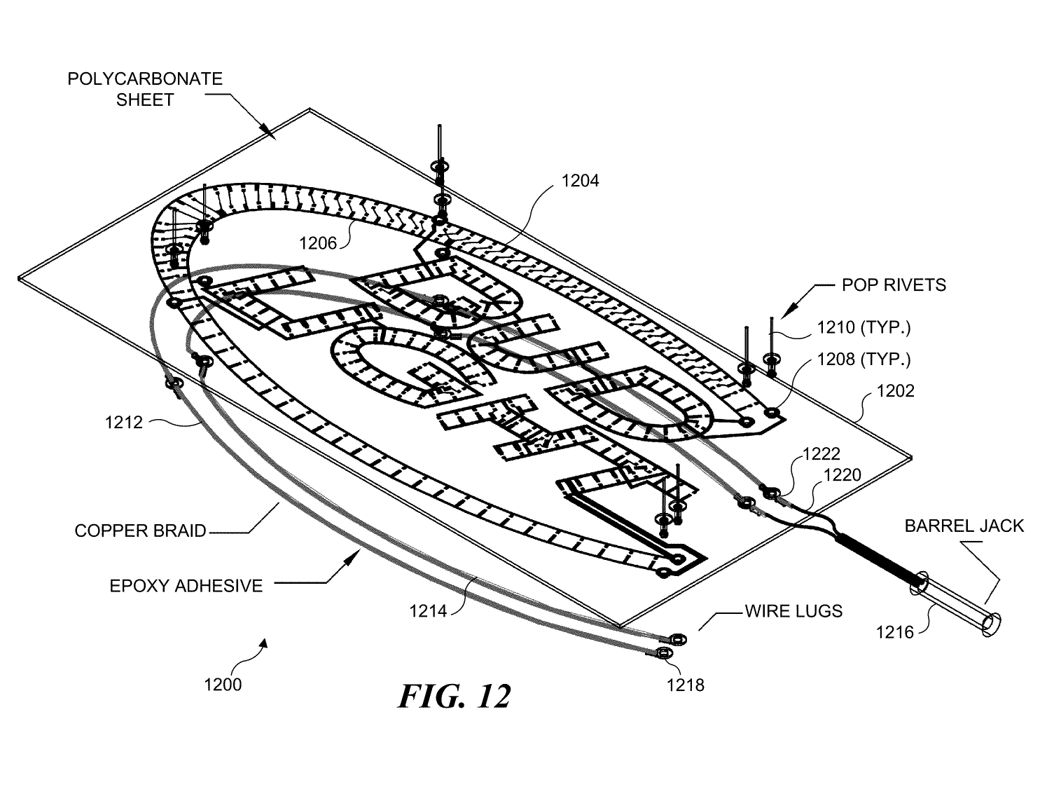

To avoid being limited to a single set of feedthroughs for energizing the power bus electrodes to which the LEDs are connected, it has been necessary to develop a non-obtrusive way of connecting feedthroughs to a common wire harness that is relatively stable and doesn't move relative to the substrate. A novel approach to accomplish this task is shown in regard to a sign 1200 in FIG. 12. Sign 1200 reads “BUD LIGHT” (like that of FIG. 2) and is formed by printing power bus electrodes 1204 and 1206 on a substrate 1202 and connecting the electrodes to LEDs used in the sign through trimmed resistors, as discussed above. At four different points, the power bus electrodes are each provided with through holes 1208. As illustrated in this Figure, stranded copper braids 1212 and 1214 can be adherently attached to an underside of signage substrate 1202 and connected at feedthroughs 1208 with wire lugs 1218 and pop rivets 1210 (or other suitable fasteners). Lead wires 1220 terminated with wire lugs 1222 are also riveted onto one of the sets of feedthroughs 1208 and extend to a connector 1216 suitable to be connected to a DC power supply. The braided copper harness can easily be hidden behind the electrodes. A voltage drop between the feedthroughs, along the braided leads can be accounted for in the network analysis, but in many instances, the braided leads can be sized to be sufficiently conductive so as to be at essentially equal voltage. It will be apparent that the complexity of the LED array and intermeshing of different letters in this circuit array pattern for sign 1200, has been made possible using the network analysis approach discussed above.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

What is claimed is:

1. Signage that includes a display that emits light when coupled to an electrical power source and defined by an electrical circuit that can include branches and loops, comprising:
(a) a substrate supporting the display; and
(b) a tuned electrode—light source—resistor network comprising:
(i) a plurality of power bus electrodes applied to the substrate and including one or more anode power bus electrode and one or more cathode power bus electrode;
(ii) a plurality of light sources mounted on the substrate so that each light source is disposed between an anode power bus electrode and a cathode power bus electrode;
(iii) a plurality of resistors used for electrically connecting the light sources in series with the plurality of power bus electrodes, wherein each resistor is trimmed to tune a combination of the anode power bus electrode, the cathode power bus electrode, and the light source to emit a desired intensity of light, the tuned electrode—light source—resistor network being tuned by controlling the resistance of the resistors to compensate for changes in voltage along the anode power bus electrode and along the cathode power bus electrode at each node where the light sources and trim resistors are connected to the plurality of power bus electrodes.

2. The signage of claim 1, wherein the display includes at least one item selected from the group consisting of:
(a) an alphanumeric character;
(b) a plurality of alphanumeric characters arrange to form at least one word or phrase; and
(c) line art.

3. The signage of claim 1, wherein the plurality of light sources comprise a plurality of light emitting diodes (LEDs).

4. The signage of claim 1, wherein the plurality of resistors comprise a conductive ink that is printed on the substrate, each resistor being trimmed by controlling at least one parameter affecting the resistance of the resistor, wherein the at least one parameter comprises at least one selected from the group consisting of:
(a) a width of the resistor as printed on the substrate;
(b) a thickness of the resistor as printed on the substrate;
(c) a length of the resistor as printed on the substrate; and
(d) a resistivity of the conductive ink used to print the resistor on the substrate.

5. The signage of claim 4, wherein the conductive ink used to print the plurality of resistors includes a material selected from the group of materials consisting of:
(a) carbon;
(b) nickel; and
(c) indium tin oxide (ITO).

6. The signage of claim 1, wherein the plurality of power bus electrodes comprise a conductive ink that is printed on the substrate.

7. The signage of claim 6, wherein the conductive ink used to print the plurality of power bus electrodes includes silver.

8. The signage of claim 1, wherein the substrate is formed of a material selected from a group of materials consisting of:
(a) a polycarbonate;
(b) a polyester;
(c) a polyimide plastic;
(d) an acrylic plastic; and
(e) glass.

9. The signage of claim 1, further comprising electrical connections for connecting a voltage source to the plurality of power bus electrodes disposed at non-adjacent points along the anode power bus electrode and the cathode power bus electrode, so that different voltage drops occur at a node on the anode power bus electrode coupled to one of the plurality of light sources than at a corresponding node on the cathode power bus electrode coupled to said one of the plurality of light sources.

10. The signage of claim 1, wherein the display comprises a plurality of discrete alphanumeric characters that can be selectively arranged to produce a desired sign or display and which is configured to connect the plurality of power bus electrodes on each discrete alphanumeric character to the electrical power source.

11. The signage of claim 1, further comprising:
(a) feedthroughs that extend through the substrate and are electrically connected to the plurality of power bus electrodes at spaced apart locations; and
(b) flexible conductive leads that are electrically connected to the feedthroughs and are attached to an opposite side of the substrate from that on which the plurality of light sources are mounted, the flexible conductive leads being used to couple to the power source to provide electrical current to the plurality of power bus electrodes.

12. The signage of claim 1, wherein the substrate is flexible and is mountable on a transparent support.

13. The signage of claim 11, wherein the flexible conductive leads are formed of a material selected from the group of materials consisting of:
(a) metallic wires having a flattened cross-sectional shape;
(b) die-cut metallic sheets;
(c) conductive metallic tape;
(d) metallic conductive bars; and
(e) metallic conductive braids.

14. The signage of claim 1, further comprising an electrical insulation pad applied to one of the plurality of power bus electrodes where a conductor coupled to a contact on another of the plurality power bus electrodes crosses over said one of the plurality of power bus electrodes.

15. The signage of claim 1, wherein the power bus electrodes may be formed by either an additive or subtractive process, and wherein the substrate and the plurality of power bus electrodes together comprise a combination selected from the group consisting of:
(a) an etched metallic flex conductor bonded to a polyimide substrate;
(b) an etched metallic conductor on a fiber reinforced plastic substrate;
(c) a conductor that is screen printed on either a polyester or polycarbonate substrate; and
(d) a metallic conductor that is mask-evaporated onto a glass substrate.

16. The signage of claim 1, wherein the substrate comprises polyester, and the resistors comprise etched indium tin oxide (ITO) formed on the substrate.

17. A method for creating a display that emits light when coupled to and energized by an electrical power source, wherein the display is defined by an electrical circuit that can include branches and loops, comprising:
(a) defining a graphic pattern for the display, wherein the electrical circuit includes a plurality of power bus electrodes generally laid out to conform to the graphic pattern, the plurality of power bus electrodes including one or more anode power bus electrode and one or more cathode power bus electrode that are disposed on opposite sides of a plurality of light sources that emit light when energized by an electrical power source, each of the plurality of light sources being electrically coupled to the anode power bus electrode and the cathode power bus electrode via one or more resistors;
(b) specifying a plurality of parameters for the electrical circuit; and
(c) based upon the plurality of parameters, creating specifications for a tuned power bus electrode—light source—resistor network in which each light source emits light at a desired intensity, by determining a resistance to which each resistor should be trimmed to compensate for changes in voltage applied to each of the plurality of light sources by the anode power bus electrode and the cathode power bus electrode.

18. The method of claim 17, wherein the graphic pattern defines at least one selected from the group consisting of:
(a) an alphanumeric character;
(b) a plurality of alphanumeric characters arranged to form at least one word or phrase;
(c) displaying one or more alphanumeric characters in a non-signage application; and
(c) line art.

19. The method of claim 18, wherein the non-signage application includes an identifying number for either a vehicle or an aircraft.

20. The method of claim 17, wherein the plurality of parameters comprise one or more selected from the group consisting of:
(a) light source parameters;
(b) resistor parameters; and
(c) electrical circuit parameters.

21. The method of claim 20, wherein the light source parameters include at least one selected from the group consisting of:
(a) a brightness for the light emitted by the light sources when energized by the power source;
(b) a pitch at which the light sources are coupled to the plurality of power bus electrodes;
(c) a current for energizing the light sources; and
(d) a volt drop across each light source.

22. The method of claim 20, wherein the resistor parameters include at least one selected from the group consisting of:
(a) a resistivity of a material comprising the resistors; and
(b) a maximum watt loading for the resistors.

23. The method of claim 20, wherein the electrical circuit parameters include at least one selected from the group consisting of:
(a) a voltage applied to the electrical circuit by the electrical power source;
(b) a resistivity of a material comprising the plurality of power bus electrodes;
(c) a width of a lead coupled to the plurality of power bus electrodes; and
(d) a width of the power bus electrodes.

24. The method of claim 17, wherein creating specifications for the tuned power bus electrode—light source—resistor network comprises performing a network analysis by:
(a) generating vector sets for each anode power bus electrode and each cathode power bus electrode, and for each branch of the electrical circuit;
(b) applying nomenclature rules to calculate voltages at branch nodes of the electrical circuit;
(c) applying a charge balance and voltage iteration to determine the resistance to which each resistor should be trimmed.

25. The method of claim 24, wherein the vectors are generated using a computer assisted drawing software package.

26. The method of claim 17, further comprising the step of creating plot files for printing the power bus electrodes and resistors on the substrate using a plotter.
